(19) United States
(12) Patent Application Publication
(10) Pub. No.: US 2026/0239478 A1
(43) Pub. Date: Aug. 13, 2026

(54) NETWORK COMMUNICATION METHOD AND APPARATUS

(71) Applicant: BEIJING XIAOMI MOBILE SOFTWARE CO., LTD., Beijing (CN)

(72) Inventors: Gaoming DUAN, Beijing (CN); Liangang CHI, Beijing (CN)

(73) Assignee: BEIJING XIAOMI MOBILE SOFTWARE CO., LTD., Beijing (CN)

(21) Appl. No.: 19/157,444

(22) PCT Filed: Feb. 28, 2023
(86) PCT No.: PCT/CN2023/078874

§ 371 Date: Aug. 18, 2025

(51) Int. Cl. H04W 76/27

(52) U.S. Cl. CPC H04W 76/27

(57) ABSTRACT

A network communication method, performed by a network device, includes: sending first configuration information of at least one first transmit and receive point (TRP) cluster to a user equipment (UE), wherein the first configuration information is used for the UE, in an idle state or an inactive state, to select a resident TRP cluster for initial access from the at least one first TRP cluster; in response to the UE completing the initial access, updating a radio resource control (RRC) state of the UE to a connected state; and sending second configuration information of a second TRP cluster to the UE, wherein the second configuration information is used for the UE, in the connected state, to access the second TRP cluster for performing data transmission.

### CROSS-REFERENCE TO RELATED APPLICATIONS

The present application is a U.S. National Phase of International Application No. PCT/CN2023/078874, filed on Feb. 28, 2023, the content of which is incorporated herein by reference in its entirety.

### TECHNICAL FIELD

The disclosure relates to the field of computer technology, in particular to a network communication method and a network communication apparatus.

### BACKGROUND

With the continuous development of wireless communication, the requirements for communication capability are getting higher. For future application scenarios such as augmented reality (AR)/virtual reality (VR), Internet of Vehicles, and Internet of Things, ultra-high rate, ultra-low latency, and ultra-large bandwidth communication will become the norm. In order to meet these requirements, more and more new technologies have been put forward. Multiple input multiple output (MIMO) technology has opened a new era in the development and utilization of spatial resources in mobile communication systems. The MIMO technology brings network devices closer to a user equipment (UE). In terms of structure, no matter where the UE moves, there will be some transmit and receive points (TRPs) close to the UE to provide services for it, and thus a multi-node cooperative transmission network architecture is required to serve the UE.

For distributed cooperative transmission, the UE needs to first access/switch to a network, and then perform cooperative transmission on a service channel. However, the traditional multi-node cooperative network architecture (e.g., cellular cell architecture) is only applied to a service data transmission stage, and no corresponding access and handover mode is configured for the UE in an initial access state.

### SUMMARY

According to a first aspect of embodiments of the disclosure, a network communication method is provided. The method is performed by a network device, and includes:
sending first configuration information of at least one first TRP cluster to a UE, in which the first configuration information is used for the UE, in an idle state or an inactive state, to select a resident TRP cluster for initial access from the at least one first TRP cluster;
in response to the UE completing the initial access, updating a radio resource control (RRC) state of the UE to a connected state; and
sending second configuration information of a second TRP cluster to the UE, in which the second configuration information is used for the UE, in the connected state, to access the second TRP cluster for performing data transmission.

According to a second aspect of embodiments of the disclosure, a network communication method is provided. The method is performed by a UE and includes:
receiving first configuration information of at least one first TRP cluster sent by a network device;
in response to the UE being in an idle state or an inactive state, selecting a resident TRP cluster for initial access from the at least one first TRP cluster according to the first configuration information, and establishing an RRC connection with the network device via the resident TRP cluster;
in response to the UE completing the initial access, receiving, in a connected state, second configuration information of a second TRP cluster sent by the network device; and
accessing the second TRP cluster according to the second configuration information to perform data transmission.

According to a third aspect of embodiments of the disclosure, a communication apparatus is provided. The communication apparatus includes a transceiver; a memory; and a processor connected to the transceiver and the memory, respectively, and configured to control wireless signal transmission and reception of the transceiver by executing computer-executable instructions on the memory, and is capable of implementing the method described in the embodiments of the first aspect of the disclosure or the method described in the embodiments of the second aspect of the disclosure.

According to a fourth aspect of embodiments of the disclosure, a non-transitory computer storage medium is provided. The computer storage medium stores computer executable instructions, when the computer executable instructions are executed by a processor, the method described in the embodiments of the first aspect of the disclosure or the method described in the embodiments of the second aspect of the disclosure is implemented.

### BRIEF DESCRIPTION OF THE DRAWINGS

The foregoing and/or additional aspects and advantages of the disclosure will become apparent and easily understood from the following description of embodiments in combination with the accompanying drawings, in which:

FIG. 1 is a flowchart of a network communication method according to an embodiment of the disclosure.

FIG. 2 is a schematic diagram of a user-centric network architecture according to an embodiment of the disclosure.

FIG. 3 is a flowchart of a network communication method according to an embodiment of the disclosure.

FIG. 4 is a flowchart of a network communication method according to an embodiment of the disclosure.

FIG. 5 is a flowchart of a network communication method according to an embodiment of the disclosure.

FIG. 6 is a sequential diagram of a network communication method according to an embodiment of the disclosure.

FIG. 7 is a block diagram of a network communication apparatus according to an embodiment of the disclosure.

FIG. 8 is a block diagram of a network communication apparatus according to an embodiment of the disclosure.

FIG. 9 is a schematic diagram of a communication apparatus according to an embodiment of the disclosure.

FIG. 10 is a schematic diagram of a chip according to an embodiment of the disclosure.

### DETAILED DESCRIPTION

Embodiments of the disclosure are described in detail below, examples of which are shown in the drawings, in which the same or similar reference numerals designate the same or similar elements or elements having the same or similar functions throughout. Embodiments described below by reference to the accompanying drawings are exemplary and are intended to explain the disclosure and should not be construed as limiting the disclosure.

With the continuous development of wireless communication, requirements for communication capabilities are becoming increasingly high. For future application scenarios such as AR/VR, Internet of Vehicles, and Internet of Things, ultra-high rate, ultra-low latency, and ultra-large bandwidth communication will become the norm. In order to meet these requirements, more and more new technologies have been put forward. MIMO technology has opened a new era in the development and utilization of spatial resources in mobile communication systems. Distributed MIMO can not only be applied to single-cell cellular base station systems, but also further replace multi-cell cellular base stations. The cellular-free mobile communication system, namely cellfree technology, is constructed in the form of distributed MU-MIMO. The cellfree technology can provide services for all users with the same time-frequency resources, without having to perform traditional inter-cell frequency division, and can dynamically schedule system resources in an all-round way. This can improve the flexibility of existing system resource configuration and greatly enhance resource utilization. For a terminal (or referred to as UE), distributed MIMO technology means that there will be a plurality of base stations serving it at the same time, without cell handover. Without the concept of cell boundaries, user experience will be smoother. In addition, serving one UE with a plurality of TRPs can better guarantee the signal quality, which may meet the high-rate and high-capacity service requirements of the UE.

Distributed ultra-large-scale MIMO pushes network devices close to the UE. In terms of structure, no matter where the UE moves, there will be some TRPs close to the UE to provide services for it, truly realizing a user-centric network structure. Therefore, network protocols and network architecture designs above a physical layer also need to match it. A multi-node cooperative transmission network architecture is required to serve the UE.

However, for achieving distributed cooperative transmission, the UE needs to first access/switch to a network, and then perform cooperative transmission on a service channel. However, the traditional multi-node cooperative network architecture (e.g., cellular cell architecture) is only applied to a service data transmission stage, and no corresponding access and handover mode is configured for the UE in an initial access state. In the multi-node cooperative transmission network architecture, how to provide corresponding access and handover modes for the UE in different states is a problem that needs to be solved urgently.

Therefore, the disclosure proposes a network communication method and a network communication apparatus, and proposes a user-centric distributed TRP networking solution. By configuring a unique TRP cluster for the UE in different states, different access and handover modes are provided for the UE in different states, and the TRP cluster may be updated with the user's movement and a change in a channel condition, thereby ensuring that the UE in an idle state or an inactive state may effectively access the network during initial access.

A network communication method and a network communication apparatus provided by the disclosure will be introduced in detail in combination with the accompanying drawings.

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the disclosure. Instead, they are merely examples of apparatuses and methods consistent with aspects related to the disclosure as recited in the attached claims.

The terms used in the embodiments of the disclosure are only for the purpose of describing specific embodiments, and are not intended to limit the embodiments of the disclosure. The singular forms of “a” and “the” used in the embodiments of the disclosure and the attached claims are also intended to include plural forms, unless the context clearly indicates other meanings. It should also be understood that the term “and/or” as used herein refers to and includes any or all possible combinations of one or more associated listed items.

It is understandable that although the terms “first”, “second”, and “third” may be used in the embodiments of the disclosure to describe various information, the information should not be limited to these terms. These terms are only used to distinguish the same type of information from each other. For example, without departing from the scope of the embodiments of the disclosure, the first information may also be referred to as the second information, and similarly, the second information may also be referred to as the first information. Depending on the context, the term “if” as used herein can be interpreted as “when”, “while” or “in response to determining”.

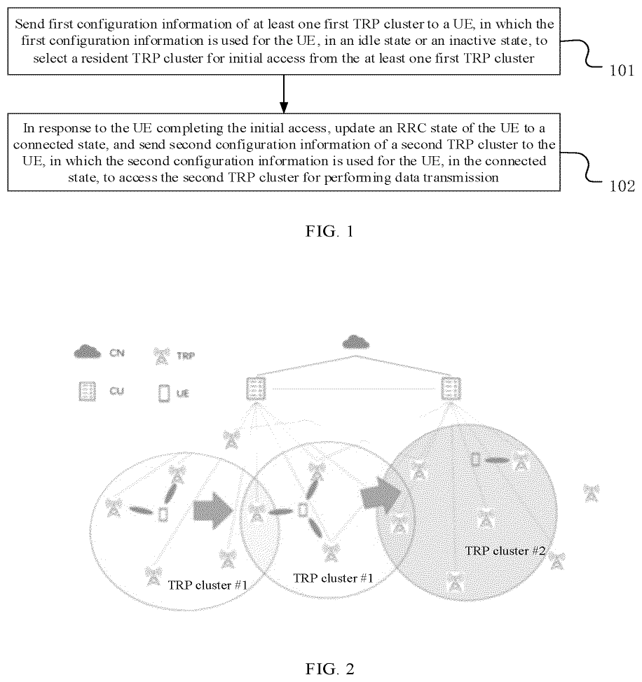

FIG. 1 illustrates a network communication method according to an embodiment of the disclosure. As illustrated in FIG. 1, the method is performed by a network device. As illustrated in FIG. 2, the network device includes a TRP cluster, a centralized unit (CU) and a central network (CN). The TRP cluster refers to a set composed of a plurality of TRPs configured by the network device for a UE, i.e. corresponding to multiple TRPs (m-TRP). The TRP cluster is unique to the UE, and some or all of the TRPs included in the TRP cluster are used to transmit data to the UE or receive data from the UE. The CU is generally connected to the plurality of TRPs via optical fibers, aggregates information from each TRP to a central controller, and performs coordinated scheduling of wireless resources. Different CUs exchange information with each other via the optical fiber or the CN. The network communication method includes the following steps.

At step 101, first configuration information of at least one first TRP cluster is sent to a UE, in which the first configuration information is used for the UE, in an idle state or an inactive state, to select a resident TRP cluster for initial access from the at least one first TRP cluster.

The initial access refers to network access of the UE in the idle state (e.g., when just powered on or exiting flight mode) or the inactive state. In this case, the UE cannot perform a TRP measurement due to a lack of prior information about TRPs, and thus cannot directly obtain a TRP cluster that meets a data transmission condition by measuring. The first configuration information may include a configuration parameter. The configuration parameter includes at least one of a time synchronization parameter, a frequency synchronization parameter or a system message. The configuration parameter may also include other parameters for the UE in the idle state or the inactive state to select the TRP cluster for the initial access from the at least one first TRP cluster, which is not specifically limited here. The time synchronization parameter may include, for example, a system frame number, a half-frame indication, etc. The frequency synchronization parameter may include, for example, an initial bandwidth part (BWP). The system message may include, for example, a public land mobile network (PLMN), a TRP cluster ID, a barred TRP cluster, etc.

In a specific application scenario, as illustrated in FIG. 2, the network device may configure a dedicated TRP cluster for each UE, and the TRP used for transmitting data to the UE may be selected from the TRP cluster. Moreover, in a networking architecture of the TRP cluster, two types of TRP clusters may be supported. A first type of TRP cluster (i.e., the first TRP cluster in embodiments of the disclosure) is mainly used for the initial access of the UE in the idle state or the inactive state, and may also be used for mobility management of the UE in a connected state. A second type of TRP cluster (i.e., a second TRP cluster in embodiments described below) serves the UE in the connected state and provides data transmission services for the UE.

In embodiments of the disclosure, as a possible implementation, the network device may send the first configuration information of the at least one first TRP cluster, for example, sending the first configuration information periodically via a broadcast channel. Since there is no uplink or downlink between the network device and the UE, the UE cannot report its position information. In this sending mode, the network device does not send the first configuration information to a specific UE in a targeted manner. When the UE in the idle state or the inactive state needs to switch its connection state, the UE may receive the first configuration information sent by the network device by performing frequency scanning, and by using the configuration parameter in the first configuration information and a reception signal strength when the first configuration information is received by performing the frequency scanning, selects, from the at least one first TRP cluster, the first TRP cluster that is allowed to reside and has the strongest signal strength as the resident TRP cluster for initiating initial random access. Then, the UE uses the resident TRP cluster to establish an RRC connection with the network device via a random access process. The network device may schedule the UE for performing uplink transmission on the basis of establishing the RRC connection.

In some embodiments of the disclosure, the method further includes: determining one or more first TRP clusters and the first configuration information of the one or more first TRP clusters. In detail, the network device may divide the first TRP clusters in different areas according to area positions, and configures the corresponding first configuration information for the first TRP clusters, respectively. After the network device sends the first configuration information via the broadcast signaling, the UE receives, by performing the frequency scanning, the first configuration information of at least one first TRP cluster in the area where the UE is located, and obtains the reception signal strength of the first configuration information during the reception process.

At step 102, in response to the UE completing the initial access, an RRC state of the UE is updated to a connected state, and second configuration information of a second TRP cluster is sent to the UE, in which the second configuration information is used for the UE, in the connected state, to access the second TRP cluster for performing data transmission.

The second configuration information includes at least one of: a TRP cluster ID; a frequency point; a bandwidth; a time domain resource position; a reference signal resource configuration; a measurement result reporting configuration; beam information; or a beam index. In addition, the second configuration information may also include other configuration information that may be used for the UE in the connected state to access the second TRP cluster for performing the data transmission, which is not specifically limited here.

In a specific application scenario, in response to the UE completing the initial access, the state of the UE is updated to the connected state. As a possible implementation, for the UE with low data transmission traffic that only needs to ensure a basic RRC connection, the resident TRP cluster may be used directly for performing the data transmission. In embodiments of the disclosure, in order to ensure a communication quality and meet the high-rate and high-capacity service requirements of the UE, as a possible implementation, after the RRC state of the UE is updated to the connected state, the network device may perform the data transmission with the UE. In detail, when the UE is in the connected state, the network device may send third configuration information and a reference signal to the UE, so that the UE may measure the reference signal according to a measurement parameter in the third configuration information to obtain a channel measurement result, and then report the channel measurement result to the network device. The network device may determine the second TRP cluster that meets the data transmission condition of the UE based on the channel measurement result, and sends the second configuration information of the second TRP cluster to the UE, so that the UE may access the second TRP cluster based on the second configuration information for the data transmission, thereby ensuring a data transmission quality of the UE. The data transmission condition may be that one or more TRPs in the second TRP cluster satisfy a maximization of channel capacity or a maximization of resource utilization, or that in one or more TRPs of the second TRP cluster, a reception quality of the UE with respect to the reference signal is greater than a preset threshold, which is not specifically limited here. It should be noted that in the steps in the following embodiments of the disclosure, the technical solution in the disclosure is description by taking the second TRP cluster, provided by the network device as a data transmission service for the UE, and the UE using the second TRP cluster for data transmission as an example, which does not constitute a specific limitation.

In conclusion, according to the network communication method provided by the disclosure, for the multi-node cooperative transmission network architecture, the network device may configure two types of TRP clusters. The first type of TRP cluster, namely, the first TRP cluster, is used for the UE in the idle state or the inactive state to establish the RRC connection with the network device. The second type of TRP cluster, namely, the second TRP cluster, is used for the UE in the RRC connected state to perform the data transmission with the network device. The network device periodically sends the first configuration information of the at least one first TRP cluster, so that when the UE is in the idle state or the inactive state, the UE may select the resident TRP cluster from the at least one first TRP cluster and completes the initial access via the resident TRP cluster. After the UE completes the initial access, the network device sends the second configuration information of the second TRP cluster to the UE, allowing the UE to access the second TRP cluster for data transmission according to the second configuration information. According to the technical solution of the disclosure, for the multi-node cooperative transmission network architecture, different access and handover modes are provided for the UE in different states, thereby ensuring that UE in the idle state or the inactive state may effectively access the network during the initial access.

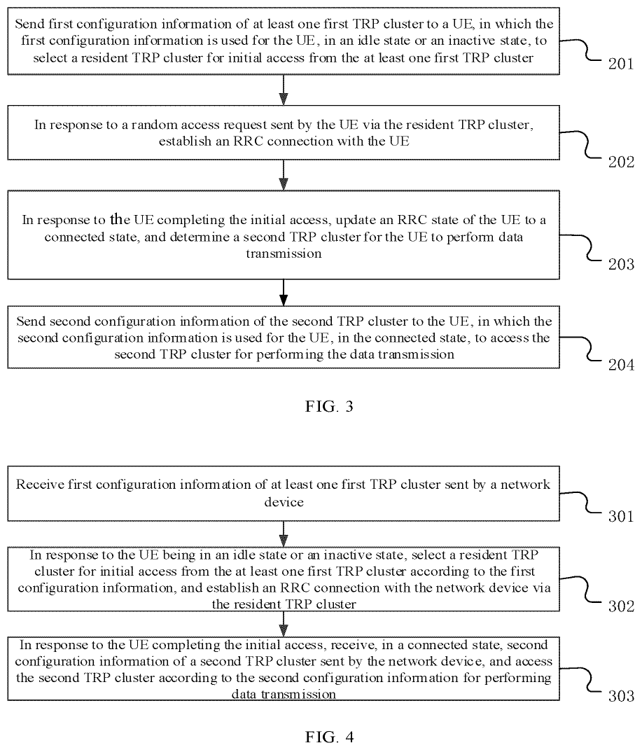

FIG. 3 illustrates a network communication method according to an embodiment of the disclosure. The method is performed by a network device. Based on the embodiment in FIG. 1, as illustrated in FIG. 3, the method includes the following steps.

At step 201, first configuration information of at least one first TRP cluster is sent to a UE, in which the first configuration information is used for the UE, in an idle state or an inactive state, to select a resident TRP cluster for initial access from the at least one first TRP cluster.

In embodiments of the disclosure, before sending the first configuration information of the at least one first TRP cluster, parameters of one or more first TRP clusters may be determined or configured. The parameters may be divided into two type, in which the first type of parameter may be a search frequency point position of the UE during the initial access agreed by a protocol. The search frequency point position is used for the UE to receive a synchronization signal and a system message, so as to complete downlink synchronization. The search frequency point position refers to a position of a search frequency point during the initial access of the UE, which is similar to a synchronization grid. The second type of parameter may be a configuration parameter determined by the network device and delivered via a broadcast signaling, i.e., the first configuration information.

In embodiments of the disclosure, the network device may periodically send the first configuration information of the at least one first TRP cluster to the UE in the idle state or the inactive state via the broadcast signaling. The UE may receive the first configuration information at the search frequency point position agreed upon by the protocol, and select the resident TRP cluster to initiate initial random access from the at least one first TRP cluster according to the first configuration information, and a random access process may be completed by using the resident TRP cluster.

At step 202, in response to a random access request sent by the UE using the resident TRP cluster, an RRC connection with the UE is established.

In a specific application scenario, after the UE selects the resident TRP cluster to initiate initial random access from the at least one first TRP cluster according to the first configuration information, the UE sends the random access request to the network device via the resident TRP cluster. Correspondingly, after receiving the random access request, the network device may complete the random access process of the UE, and the UE then enters the RRC connected state.

At step 203, in response to the UE completing the initial access, an RRC state of the UE is updated to a connected state, and a second TRP cluster for the UE to perform data transmission is determined.

In embodiments of the disclosure, when the network device determines the second TRP cluster for the UE to perform the data transmission, as a possible implementation, after the RRC state of the UE is updated to the connected state, the network device may perform data transmission with the UE. In detail, the network device sends third configuration information and a reference signal to the UE in the connected state, so that the UE may measure the reference signal according to a measurement parameter in the third configuration information to obtain a channel measurement result, and report the channel measurement result to the network device. The network device may determine the second TRP cluster that meets a data transmission condition of the UE according to the channel measurement result. Alternatively, after determining the second TRP cluster, the network device may also update the second TRP cluster for the UE to perform the data transmission according to UE's movement and/or a change in a channel condition.

The third configuration information may include a measurement parameter for the UE to measure the reference signal and a reporting configuration for the UE to report the channel measurement result. The measurement parameter includes at least one of a number of transmission times of the reference signal, a transmission resource, a frequency point, or a measurement quantity, etc. The reporting configuration includes at least one of periodic reporting, semi-periodic reporting, or non-periodic reporting. After updating the state of the UE to the RRC connected state, the network device may send the third configuration information and the reference signal to the UE, enabling the UE to measure the reference signal according to the measurement parameter in the third configuration information to obtain the channel measurement result. After obtaining the channel measurement result, the UE may report, according to the reporting configuration in the configuration information, the channel measurement result obtained by measurement. Correspondingly, the network device may receive the channel measurement result sent by the UE. The channel measurement result is used to reflect a data transmission quality, i.e., a channel quality, of a TRP cluster configured corresponding to the UE.

It should be noted that the network device may send the third configuration information and the reference signal to the UE simultaneously, or may send the third configuration information to the UE first and then send the reference signal to the UE. The sending order of the third configuration information and the reference signal is not specifically limited here.

In embodiments of the disclosure, after the network device establishes the RRC connection with the UE, the network device may obtain position information of the UE, and then send the third configuration information and the reference signal to the UE by using TRPs around the UE, so as to implement the measurement of the reference signal. The network device also determines or updates the second TRP cluster for the UE to perform the data transmission based on the channel measurement result. Correspondingly, after receiving the channel measurement result sent by the UE, the network device may analyze the channel measurement result obtained by the measurement performed by the UE according to the third configuration information, and determine the second TRP cluster with a better data transmission quality, i.e., meeting the data transmission condition of UE, under the current movement state and the channel condition of the UE. The data transmission condition may be that one or more TRPs in the second TRP cluster satisfy a maximization of channel capacity or a maximization of resource utilization, or that in one or more TRPs of the second TRP cluster, a reception quality of the UE with respect to the reference signal is greater than a preset threshold, which is not specifically limited here.

At step 204, second configuration information of the second TRP cluster is sent to the UE, in which the second configuration information is used for the UE, in the connected state, to access the second TRP cluster for performing the data transmission.

For the embodiment of the disclosure, the specific implementation may refer to the related description in the embodiment of step 102, which is not repeated here.

In summary, according to the network communication method provided by the disclosure, for the multi-node cooperative transmission network architecture, the network device is configured with two types of TRP clusters. By periodically sending the first configuration information of the at least one first TRP cluster, the UE, in the idle state or the inactive state, can select the resident TRP cluster from the at least one first TRP cluster, and then complete the initial access via the resident TRP cluster. After the initial access is completed, the network device sends the second configuration information of the second TRP cluster to the UE, so that the UE can access the second TRP cluster for data transmission according to the second configuration information. For the multi-node cooperative transmission network architecture, the technical solution disclosed in the disclosure can provide corresponding access and handover modes for the UE in different states, thereby ensuring that the UE, in the idle state or the inactive state, can effectively access the network during the initial access.

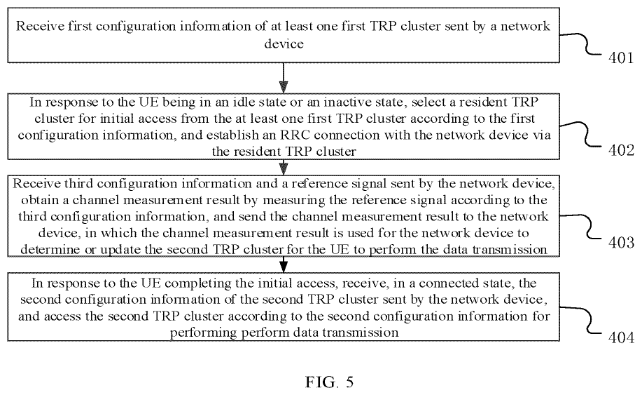

FIG. 4 illustrates a network communication method according to an embodiment of the disclosure. As illustrated in FIG. 4, the method is performed by a UE, and includes the following steps.

At step 301, first configuration information of at least one first TRP cluster sent by a network device is received.

The first configuration information may include a configuration parameter. The configuration parameter includes at least one of a time synchronization parameter, a frequency synchronization parameter or a system message. The configuration parameter may also include other parameters for the UE in the idle state or the inactive state to select the TRP cluster for the initial access from the at least one first TRP cluster, which is not specifically limited here. The time synchronization parameter may include, for example, a system frame number, a half-frame indication, etc. The frequency synchronization parameter may include, for example, an initial bandwidth part (BWP). The system message may include, for example, a public land mobile network (PLMN), a TRP cluster ID, a barred TRP cluster, etc.

In a specific application scenario, the network device may send the first configuration information of the at least one first TRP cluster, for example, sending the first configuration information periodically via a broadcast channel. Since there is no uplink or downlink between the network device and the UE, the UE cannot report its position information. In this sending mode, the network device does not send the first configuration information to a specific UE in a targeted manner. In embodiments of the disclosure, when the UE in the idle state or the inactive state needs to switch its connection state, the UE may receive the first configuration information of the at least one first TRP cluster by performing frequency scanning in the area where the UE is located.

At step 302, in response to the UE being in an idle state or an inactive state, a resident TRP cluster for initial access is selected from the at least one first TRP cluster according to the first configuration information, and an RRC connection with the network device is established by using the resident TRP cluster.

The initial access refers to network access of the UE in the idle state (e.g., when just powered on or exiting flight mode) or the inactive state. In this case, the UE cannot perform a TRP measurement due to a lack of prior information about TRPs

In a specific application scenario, as illustrated in FIG. 2, the network device may configure a dedicated TRP cluster for each UE, and the TRP used for transmitting data to the UE may be selected from the TRP cluster. Moreover, in a networking architecture of the TRP cluster, two types of TRP clusters may be supported. A first type of TRP cluster (i.e., the first TRP cluster in embodiments of the disclosure) is mainly used for the initial access of the UE in the idle state or the inactive state, and may also be used for mobility management of the UE in a connected state. A second type of TRP cluster (i.e., a second TRP cluster in embodiments described below) serves the UE in the connected state and provides data transmission services for the UE.

In embodiments of the disclosure, as a possible implementation, the UE in the idle state or the inactive state may receive the first configuration information of the at least one first TRP cluster sent by the network device periodically by performing the frequency scanning. During the process of receiving the first configuration information by performing the frequency scanning, a reception signal strength of the first configuration information may also be obtained. Subsequently, the UE may utilize the configuration parameter in the first configuration information and the reception signal strength during receiving the first configuration information by the frequency scanning to select, from at least one first TRP cluster, the first TRP cluster that is allowed to reside and has the strongest signal strength as the resident TRP cluster for initiating initial random access. Then, the UE uses the resident TRP cluster to initiate the random access procedure, completes the random access procedure and uplink synchronization, and also establishes the RRC connection with the network device to enter the RRC connected state. The network device may schedule the UE for performing uplink transmission on the basis of establishing the RRC connection.

At step 303, in response to the UE completing the initial access, second configuration information of a second TRP cluster sent by the network device is received in a connected state, and the second TRP cluster is accessed according to the second configuration information for performing data transmission.

The second configuration information includes at least one of: a TRP cluster ID; a frequency point; a bandwidth; a time domain resource position; a reference signal resource configuration; a measurement result reporting configuration; beam information; or a beam index. In addition, the second configuration information may also include other configuration information that may be used for the UE in the connected state to access the second TRP cluster for performing the data transmission, which is not specifically limited here.

In embodiments of the disclosure, as a possible implementation, in response to the UE completing the initial access and the RRC state of the UE is updated to the RRC connected state, as a possible implementation, for the UE with low data transmission traffic that only needs to ensure a basic RRC connection, the resident TRP cluster may be used directly for the data transmission. As a possible implementation, in order to ensure a communication quality and meet the high-rate and high-capacity service requirements of the UE, after the RRC state of the UE is updated to the connected state, the network device may perform the data transmission with the UE. In detail, when the UE is in the connected state, the network device may send third configuration information and a reference signal to the UE, so that the UE may measure the reference signal according to a measurement parameter in the third configuration information to obtain a channel measurement result, and then report the channel measurement result to the network device. The network device may determine the second TRP cluster that meets the data transmission condition of the UE according to the channel measurement result, and sends the second configuration information of the second TRP cluster to the UE. Correspondingly, the UE may receive the second configuration information of the second TRP cluster sent by the network device, and access the second TRP cluster for the data transmission according to the second configuration information, thereby ensuring a data transmission quality of the UE. The data transmission condition may be that one or more TRPs in the second TRP cluster satisfy a maximization of channel capacity or a maximization of resource utilization, or that in one or more TRPs of the second TRP cluster, a reception quality of the UE with respect to the reference signal is greater than a preset threshold, which is not specifically limited here. It should be noted that in the steps in the following embodiments of the disclosure, the technical solution in the disclosure is description by taking the second TRP cluster, provided by the network device as a data transmission service for the UE, and the UE using the second TRP cluster for data transmission as an example, which does not constitute a specific limitation.

In conclusion, according to the network communication method provided by the disclosure, for the multi-node cooperative transmission network architecture, when the UE in the idle state or the inactive state performs the initial access, the UE may select the resident TRP cluster for the initial access from the at least one first TRP cluster according to the first configuration information sent by the network device, and establish the RRC connection with the network device by using the resident TRP cluster. After entering the RRC connected state, the UE may receive the second configuration information of the second TRP cluster sent by the network device, and access the second TRP cluster for the data transmission according to the second configuration information. According to the technical solution of the disclosure, for the multi-node cooperative transmission network architecture, different access and handover modes are provided for the UE in different states, thereby ensuring that UE in the idle state or the inactive state may effectively access the network during the initial access.

FIG. 5 illustrates a network communication method according to an embodiment of the disclosure. The method is performed by a UE. Based on the embodiment in FIG. 4, as illustrated in FIG. 5, the method includes the following steps.

At step 401, first configuration information of at least one first TRP cluster sent by a network device is received.

In a specific application scenario, before receiving the first configuration information of the at least one first TRP cluster sent by the network device, the UE may determine a search frequency point position during the initial access via a protocol agreement. The search frequency point position is used for the UE to receive a synchronization signal and a system message, so as to complete downlink synchronization. The search frequency point position refers to a position of a search frequency point during the initial access of the UE, which is similar to a synchronization grid. In embodiments of the disclosure, as a possible implementation, the UE may receive, at the search frequency point position, a configuration parameter periodically sent by the network device via a broadcast signaling. The configuration parameter includes, but is not limited to, at least one of a time synchronization parameter, a frequency synchronization parameter or a system message.

At step 402, in response to the UE being in an idle state or an inactive state, a resident TRP cluster for initial access is selected from the at least one first TRP cluster according to the first configuration information, and an RRC connection with the network device is established via the resident TRP cluster.

In embodiments of the disclosure, the UE may select the resident TRP cluster to initiate initial random access from the at least one first TRP cluster according to the first configuration information, and sends a random access request to the network device via the resident TRP cluster, so that the network device establishes the RRC connection with the UE in response to the random access request. The UE enters the RRC connected state. When the UE selects the resident TRP cluster from the first TRP clusters, as a possible implementation, the first TRP cluster with the strongest signal among the TRP cluster allowed to reside in the at least one first TRP cluster may be selected as the resident TRP cluster.

At step 403, third configuration information and a reference signal sent by the network device are received, a channel measurement result is obtained by measuring the reference signal according to the third configuration information, and the channel measurement result is sent to the network device, in which the channel measurement result is used for the network device to determine or update the second TRP cluster for the UE to perform the data transmission.

The third configuration information includes a measurement parameter for the UE to measure the reference signal and a reporting configuration for the UE to report the channel measurement result. The measurement parameter includes at least one of a number of transmission times of the reference signal, a transmission resource, a frequency point, or a measurement quantity, etc. The reporting configuration includes at least one of periodic reporting, semi-periodic reporting, or non-periodic reporting. The network device sends the third configuration information and the reference signal to the UE, to enable the UE to measure the reference signal according to the measurement parameter in the third configuration information and to obtain the channel measurement result. After obtaining the channel measurement result, the UE may report, according to the reporting configuration in the configuration information, the channel measurement result obtained by measurement. Correspondingly, the network device may receive the channel measurement result sent by the UE. The channel measurement result is used to reflect a data transmission quality, i.e., a channel quality, of a TRP cluster configured corresponding to the UE. After receiving the channel measurement result, the network device may further determine, according to the channel measurement result, the second TRP cluster with a better data transmission quality, i.e., meeting the data transmission condition of UE, under the current movement state and the channel condition of the UE. Alternatively, after determining the second TRP cluster, the network device may also update the second TRP cluster for the UE to perform the data transmission according to UE's movement and/or a change in a channel condition.

At step 404, in response to the UE completing the initial access, the second configuration information of the second TRP cluster sent by the network device is received in a connected state, and the second TRP cluster is accessed according to the second configuration information for performing data transmission.

The second TRP cluster is a TRP cluster determined by the network device, after receiving the channel measurement result sent by the UE, through analyzing the channel measurement result obtained by the measurement performed by the UE according to the third configuration information, which has a better data transmission quality, i.e., meeting the data transmission condition of UE, under the current movement state and the channel condition of the terminal device. The data transmission condition may be that one or more TRPs in the second TRP cluster satisfy a maximization of channel capacity or a maximization of resource utilization, or that in one or more TRPs of the second TRP cluster, a reception quality of the UE with respect to the reference signal is greater than a preset threshold, which is not specifically limited here. In embodiments of the disclosure, after receiving the second configuration information of the second TRP cluster sent by the network device, the UE may directly access the second TRP cluster for the data transmission based on the second configuration information.

In conclusion, according to the network communication method provided by the disclosure, for the multi-node cooperative transmission network architecture, when the UE is in the idle state or the inactive state, the UE may select the resident TRP cluster for the initial access from the at least one first TRP cluster according to the first configuration information sent by the network device, and establish the RRC connection with the network device via the resident TRP cluster. After entering the RRC connected state, the UE may receive the second configuration information of the second TRP cluster sent by the network device, and access the second TRP cluster for the data transmission according to the second configuration information. According to the technical solution of the disclosure, for the multi-node cooperative transmission network architecture, different access and handover modes are provided for the UE in different states, thereby ensuring that UE in the idle state or the inactive state may effectively access the network during the initial access.

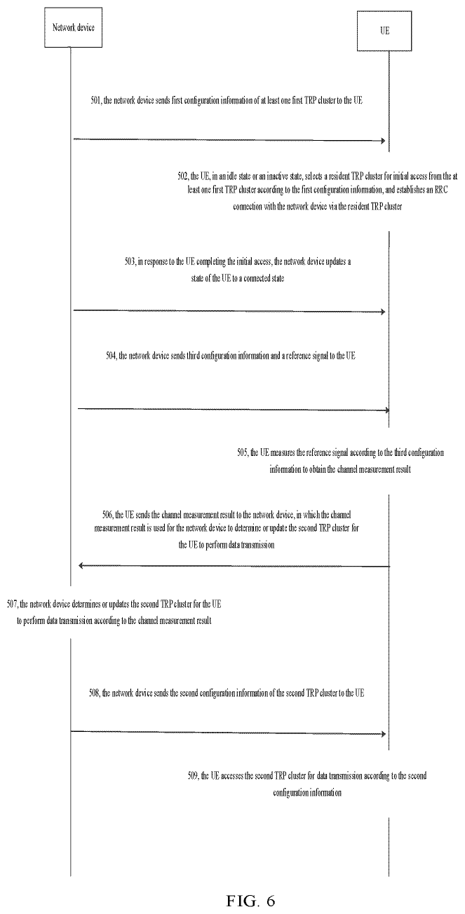

FIG. 6 is a sequential diagram of a network communication method according to an embodiment of the disclosure. The method is applied to a communication system. The system includes: a network device and a UE. The network device includes TRP clusters, a CU and a CN in FIG. 2. During specific execution, the network device may periodically send first configuration information of at least one first TRP cluster to the UE. The first configuration information is used for the UE, in an idle state or an inactive state, to select a resident TRP cluster for initial access from the at least one first TRP cluster. The UE, in the idle state or the inactive state, selects the resident TRP cluster for the initial access from the at least one first TRP cluster according to the first configuration information, and establishes an RRC connection with the network device via the resident TRP cluster. The network device updates a state of the UE to a connected state in response to the UE completing the initial access. The network device sends third configuration information and a reference signal to the UE. The UE measures the reference signal according to the third configuration information to obtain a channel measurement result. The UE sends the channel measurement result to the network device. The network device determines or updates a second TRP cluster used for the UE to perform data transmission according to the channel measurement result. The network device sends second configuration information of the second TRP cluster to the UE. The UE accesses the second TRP cluster for the data transmission according to the second configuration information.

As illustrated in FIG. 6, the method includes the following steps.

At step 501, the network device sends first configuration information of at least one first TRP cluster to the UE.

The first configuration information is used for the UE, in the idle state or the inactive state, to select a resident TRP cluster from the at least one first TRP cluster for initiating initial access. The initial access refers to network access of the UE in the idle state (e.g., when just powered on or exiting flight mode) or the inactive state. In this case, the UE cannot perform a TRP measurement due to a lack of prior information about TRPs, and thus cannot directly obtain a TRP cluster that meets a data transmission condition by measuring. The first configuration information may include a configuration parameter. The configuration parameter includes at least one of a time synchronization parameter, a frequency synchronization parameter or a system message. The configuration parameter may also include other parameters for the UE in the idle state or the inactive state to select the TRP cluster for the initial access from the at least one first TRP cluster, which is not specifically limited here. The time synchronization parameter may include, for example, a system frame number, a half-frame indication, etc. The frequency synchronization parameter may include, for example, an initial bandwidth part (BWP). The system message may include, for example, a public land mobile network (PLMN), a TRP cluster ID, a barred TRP cluster, etc.

In embodiments of the disclosure, as a possible implementation, the network device may send the first configuration information of the at least one first TRP cluster, for example, sending the first configuration information periodically via a broadcast channel. Since there is no uplink or downlink between the network device and the UE, the UE cannot report its position information. In this sending mode, the network device does not send the first configuration information to a specific UE in a targeted manner. When the UE in the idle state or the inactive state needs to switch its connection state, the UE may receive the first configuration information sent by the network device by performing frequency scanning, and by using the configuration parameter in the first configuration information and a reception signal strength when the first configuration information is received by performing the frequency scanning, selects, from the at least one first TRP cluster, the first TRP cluster that is allowed to reside and has the strongest signal strength as the resident TRP cluster for initiating initial random access. Then, the UE uses the resident TRP cluster to establish an RRC connection with the network device via a random access process. The network device may schedule the UE for performing uplink transmission on the basis of establishing the RRC connection.

In some embodiments of the disclosure, the method further includes: determining one or more first TRP clusters and the first configuration information of the one or more first TRP clusters. In detail, the network device may divide the first TRP clusters in different areas according to area positions, and configures the corresponding first configuration information for the first TRP clusters, respectively. After the network device sends the first configuration information via the broadcast signaling, the UE receives, by performing the frequency scanning, the first configuration information of at least one first TRP cluster in the area where the UE is located, and obtains the reception signal strength of the first configuration information during the reception process.

At step 502, the UE, in an idle state or an inactive state, selects a resident TRP cluster for initial access from the at least one first TRP cluster according to the first configuration information, and establishes an RRC connection with the network device via the resident TRP cluster.

In embodiments of the disclosure, as a possible implementation, the UE in the idle state or the inactive state may receive the first configuration information of the at least one first TRP cluster sent by the network device periodically by performing the frequency scanning. During the process of receiving the first configuration information by performing the frequency scanning, a reception signal strength of the first configuration information may also be obtained. Subsequently, the UE may utilize the configuration parameter in the first configuration information and the reception signal strength during receiving the first configuration information by the frequency scanning to select, from at least one first TRP cluster, the first TRP cluster that is allowed to reside and has the strongest signal strength as the resident TRP cluster for initiating initial random access. Then, the UE uses the resident TRP cluster to initiate the random access procedure, completes the random access procedure and uplink synchronization, and also establishes the RRC connection with the network device to enter the RRC connected state. The network device may schedule the UE for performing uplink transmission on the basis of establishing the RRC connection.

At step 503, in response to the UE completing the initial access, the network device updates a state of the UE to a connected state.

In embodiments of the disclosure, the network device establishes the RRC connection with the UE in response to a random access request sent by the UE via the resident TRP cluster, and updates the state of the UE to the RRC connected state. The network device may determine a second TRP cluster that provides data transmission services for the UE in the RRC connected state, and send second configuration information of the second TRP cluster to the UE, so that the UE may access the second TRP cluster for data transmission based on the second configuration information.

Correspondingly, when the UE completes the initial access and the state of the UE is updated to the RRC connected state, as a possible implementation, for the UE with low data transmission traffic that only needs to ensure a basic RRC connection, the resident TRP cluster may be used directly for performing the data transmission. That is, the embodiments in subsequent steps 504-509 will not be executed. As a possible implementation, in order to ensure the communication quality and meet the high-rate and high-capacity service requirements of the UE, the network device may determine the second TRP cluster that provides data transmission services for the UE, and send the second configuration information of the second TRP cluster to the UE. Correspondingly, the UE may receive the second configuration information of the second TRP cluster sent by the network device, and access the second TRP cluster for performing the data transmission according to the second configuration information, thereby ensuring a data transmission quality of the UE. It should be noted that in the steps in the following embodiments of the disclosure, the technical solution in the disclosure is description by taking the second TRP cluster, provided by the network device as a data transmission service for the UE, and the UE using the second TRP cluster for data transmission as an example, which does not constitute a specific limitation.

At step 504, the network device sends third configuration information and a reference signal to the UE.

In embodiments of the disclosure, when the network device determines the second TRP cluster for the UE to perform the data transmission, as a possible implementation, after the RRC state of the UE is updated to the connected state, the network device may perform data transmission with the UE. In detail, the network device sends third configuration information and a reference signal to the UE in the connected state, so that the UE may measure the reference signal according to a measurement parameter in the third configuration information to obtain a channel measurement result, and report the channel measurement result to the network device. The network device may determine the second TRP cluster that meets a data transmission condition of the UE according to the channel measurement result. Alternatively, after determining the second TRP cluster, the network device may also update the second TRP cluster for the UE to perform the data transmission according to UE's movement and/or a change in a channel condition.

The third configuration information includes a measurement parameter for the UE to measure the reference signal and a reporting configuration for the UE to report the channel measurement result. The measurement parameter includes at least one of a number of transmission times of the reference signal, a transmission resource, a frequency point, or a measurement quantity, etc. The reporting configuration includes at least one of periodic reporting, semi-periodic reporting, or non-periodic reporting. The network device sends the third configuration information and the reference signal to the UE, to enable the UE to measure the reference signal according to the measurement parameter in the third configuration information and to obtain the channel measurement result. After obtaining the channel measurement result, the UE may report, according to the reporting configuration in the configuration information, the channel measurement result obtained by measurement. Correspondingly, the network device may receive the channel measurement result sent by the UE. The channel measurement result is used to reflect a data transmission quality, i.e., a channel quality, of a TRP cluster configured corresponding to the UE.

It should be noted that the network device may send the third configuration information and the reference signal to the UE simultaneously, or may send the third configuration information to the UE first and then send the reference signal to the UE. The transmission order of the third configuration information and the reference signal is not specifically limited here.

At step 505, the UE measures the reference signal according to the third configuration information to obtain the channel measurement result.

At step 506, the UE sends the channel measurement result to the network device, in which the channel measurement result is used for the network device to determine or update the second TRP cluster for the UE to perform data transmission.

In embodiments of the disclosure, the UE measures the reference signal according to the measurement parameter in the third configuration information to obtain the channel measurement result. After obtaining the channel measurement result, the UE may report, according to the reporting configuration in the configuration information, the channel measurement result obtained by measurement. Correspondingly, the network device may receive the channel measurement result sent by the UE. The channel measurement result is used to reflect a data transmission quality, i.e., a channel quality, of a TRP cluster configured corresponding to the UE.

At step 507, the network device determines or updates the second TRP cluster for the UE to perform data transmission according to the channel measurement result.

In embodiments of the disclosure, after receiving the channel measurement result sent by the UE, the network device may analyze the channel measurement result obtained by the measurement performed by the UE according to the third configuration information, and determine the second TRP cluster with a better data transmission quality, i.e., meeting the data transmission condition of UE, under the current movement state and the channel condition of the UE. Alternatively, after determining the second TRP cluster, the network device may also update the second TRP cluster for the UE to perform the data transmission according to UE's movement and/or a change in a channel condition. The data transmission condition may be that one or more TRPs in the second TRP cluster satisfy a maximization of channel capacity or a maximization of resource utilization, or that in one or more TRPs of the second TRP cluster, a reception quality of the UE with respect to the reference signal is greater than a preset threshold, which is not specifically limited here.

At step 508, the network device sends the second configuration information of the second TRP cluster to the UE.

At step 509, the UE accesses the second TRP cluster for data transmission according to the second configuration information.

According to the network communication method provided in the embodiment, for the multi-node cooperative transmission network architecture, when the UE is in the idle state or the inactive state, the UE may select the resident TRP cluster for the initial access from the at least one first TRP cluster according to the first configuration information sent by the network device, and establish the RRC connection with the network device via the resident TRP cluster. After entering the RRC connected state, the UE may receive the second configuration information of the second TRP cluster sent by the network device, and access the second TRP cluster for the data transmission according to the second configuration information. According to the technical solution of the disclosure, for the multi-node cooperative transmission network architecture, different access and handover modes are provided for the UE in different states, thereby ensuring that UE in the idle state or the inactive state may effectively access the network during the initial access.

In the above embodiments provided by the disclosure, the methods provided in the embodiments of the disclosure are introduced from the perspectives of the network device and the UE, respectively. In order to implement various functions of the methods provided in the above-mentioned embodiments of the disclosure, the network device and the UE may include a hardware structure and a software module, and implement the above-mentioned functions in the form of the hardware structure, the software module, or a combination of the hardware structure and the software module. Any of the above functions may be implemented in the form of the hardware structure, the software module, or a combination of the hardware structure and the software module.

Corresponding to the network communication method provided in the above-mentioned embodiments, the disclosure provides a network communication apparatus. Since the network communication apparatus provided in the embodiment of the disclosure corresponds to the network communication method provided in the above-mentioned embodiments, the implementation of the network communication method is also applicable to the network communication apparatus provided in the embodiment, which will not be described in detail in the embodiment.

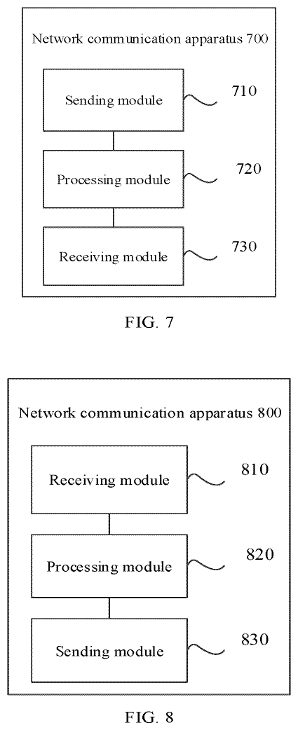

FIG. 7 is a schematic structural diagram of a network communication apparatus 700 according to an embodiment of the disclosure. The network communication apparatus 700 may be applied to the network device.

As illustrated in FIG. 7, the apparatus 700 includes:
a sending module 710, configured to send first configuration information of at least one first TRP cluster to a UE, in which the first configuration information is used for the UE, in an idle state or an inactive state, to select a resident TRP cluster for initial access from the at least one first TRP cluster; and
a processing module 720, configured to, in response to the UE completing the initial access, update an RRC state of the UE to a connected state.

The sending module 710 is further configured to send second configuration information of a second TRP cluster to the UE, in which the second configuration information is used for the UE, in the connected state, to access the second TRP cluster for performing data transmission.

In some embodiments of the disclosure, the processing module 720 is configured to: determine, via a protocol agreement, a search frequency point position of the UE during the initial access, in which the search frequency point position is used for the UE to receive a synchronization signal and a system message to complete downlink synchronization.

In some embodiments of the disclosure, the first configuration information includes a configuration parameter, and the sending module 710 is configured to: send the configuration parameter periodically via a broadcast signaling, in which the configuration parameter includes at least one of a time synchronization parameter, a frequency synchronization parameter or a system message.

In some embodiments of the disclosure, the processing module 720 is configured to: in response to a random access request sent by the UE using the resident TRP cluster, establish an RRC connection with the UE.

In some embodiments of the disclosure, the processing module 720 is configured to: send third configuration information and a reference signal to the UE, in which the third configuration information is used for the UE to measure the reference signal to obtain a channel measurement result.

In some embodiments of the disclosure, the processing module 720 is configured to: determine or update the second TRP cluster for the UE to perform the data transmission according to the channel measurement result.

In some embodiments of the disclosure, as illustrated in FIG. 7, the apparatus further includes: a receiving module 730.

The receiving module 730 is configured to: receive the channel measurement result sent by the UE.

In some embodiments of the disclosure, the second configuration information includes at least one of:
a TRP cluster ID;
a frequency point;
a bandwidth;
a time domain resource position;
a reference signal resource configuration;
a measurement result reporting configuration;
beam information; or
a beam index.

FIG. 8 is a schematic structural diagram of a network communication apparatus 800 according to an embodiment of the disclosure. The network communication apparatus 800 may be applied to the UE.

As illustrated in FIG. 8, the apparatus 800 includes:
a receiving module 810, configured to receive first configuration information of at least one first TRP cluster sent by a network device;
a processing module 820, configured to, in response to the UE being in an idle state or an inactive state, select a resident TRP cluster for initial access from the at least one first TRP cluster according to the first configuration information, and establish an RRC connection with the network device by using the resident TRP cluster; and
the receiving module 810, further configured to, in response to the UE completing the initial access, receive, in a connected state, second configuration information of a second TRP cluster sent by the network device.

The processing module 820 is further configured to access the second TRP cluster according to the second configuration information for performing data transmission.

In some embodiments of the disclosure, the processing module 820 is further configured to: determine, via a protocol agreement, a search frequency point position during the initial access, in which the search frequency point position is used for the UE to receive a synchronization signal and a system message to complete downlink synchronization.

In some embodiments of the disclosure, the first configuration information includes a configuration parameter, and the receiving module 810 is further configured to: receive, at the search frequency point position, the configuration parameter periodically sent by the network device via a broadcast signaling, in which the configuration parameter includes at least one of a time synchronization parameter, a frequency synchronization parameter or a system message.

In some embodiments of the disclosure, as illustrated in FIG. 8, the apparatus 800 further includes: a sending module 830.

The sending module 830 is configured to: send a random access request to the network device via the resident TRP cluster, to cause the network device to establish the RRC connection with the UE in response to the random access request.

In some embodiments of the disclosure, the receiving module 810 is further configured to: receive third configuration information and a reference signal sent by the network device. The processing module 820 is further configured to: measure the reference signal according to the third configuration information to obtain a channel measurement result.

In some embodiments of the disclosure, the sending module 830 is further configured to: send the channel measurement result to the network device, in which the channel measurement result is used for the network device to determine or update the second TRP cluster for the UE to perform the data transmission.

In some embodiments of the disclosure, the second configuration information includes at least one of:
a TRP cluster ID;
a frequency point;
a bandwidth;
a time domain resource position;
a reference signal resource configuration;
a measurement result reporting configuration;
beam information; or
a beam index.

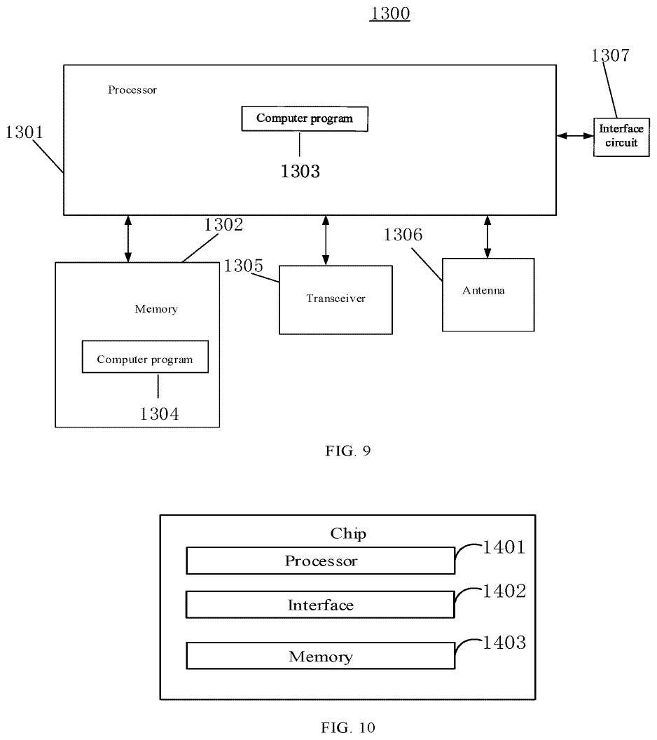

FIG. 9 is a schematic structural diagram of a communication apparatus 1300 provided by an embodiment of the disclosure. The communication apparatus 1300 may be a network device, a UE, or a chip, a chip system or a processor that supports the network device to implement the above methods, or a chip, a chip system or a processor that supports the UE to implement the above methods. The device may be used to realize the methods described in the above method embodiments with reference to the descriptions of the above-described method embodiments.

The communication apparatus 1300 may include one or more processors 1301. The processor 1301 may be a general purpose processor or a dedicated processor, such as, a baseband processor or a central processor. The baseband processor is used for processing communication protocols and communication data. The central processor is used for controlling a communication apparatus (e.g., base station, baseband chip, UE, UE chip, CU or distributed unit (DU)), executing computer programs, and processing data of the computer programs.

In an embodiment of the disclosure, the communication apparatus 1300 may further include one or more memories 1302 on which a computer program 1304 may be stored. When the processor 1301 executes the computer program 1304, the communication apparatus 1300 is caused to perform the methods described in the above method embodiments. In an embodiment of the disclosure, the memory 1302 may also store data. The communication apparatus 1300 and the memory 1302 may be provided separately or may be integrated together.

In an embodiment of the disclosure, the communication apparatus 1300 may also include a transceiver 1305 and an antenna 1306. The transceiver 1305 may be referred to as transceiver unit, transceiver machine, or transceiver circuit, for realizing a transceiver function. The transceiver 1305 may include a receiver and a transmitter. The receiver may be referred to as receiver machine or receiving circuit, for realizing a receiving function. The transmitter may be referred to as transmitter machine or transmitting circuit, for realizing a transmitting function.

In an embodiment of the disclosure, the communication apparatus 1300 may also include one or more interface circuits 1307. The interface circuits 1307 are used to receive code instructions and transmit them to the processor 1301. The processor 1301 runs the code instructions to cause the communication apparatus 1300 to perform the methods described in the method embodiments.

In an implementation, the processor 1301 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 1301 may store a computer program 1303 that can be executed by the processor 1301 and may cause the communication apparatus 1300 to perform the methods described in the method embodiments above. The computer program 1303 may be solidified in the processor 1301, in which case the processor 1301 may be implemented by hardware.

In an implementation, the communication apparatus 1300 may include circuits. The circuits may implement the sending, receiving or communicating function in the preceding method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver can also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication apparatus in the descriptions of the above embodiments may be a network device or a UE, but the scope of the communication apparatus described in the disclosure is not limited thereto, and the structure of the communication apparatus may not be limited by FIG. 9. The communication apparatus may be a stand-alone device or may be part of a larger device. For example, the described communication apparatus may be:
(1) a stand-alone IC, chip, chip system or subsystem;
(2) a collection of ICs including one or more ICs, in an embodiment of the disclosure, the collection of ICs may also include storage components for storing data and computer programs;
(3) an ASIC, such as a modem;
(4) modules that can be embedded within other devices;
(5) receivers, UEs, smart UEs, cellular phones, wireless devices, handheld machines, mobile units, in-vehicle devices, network devices, cloud devices, artificial intelligence devices, and the like; and
(6) others.

The case that the communication apparatus may be a chip or a chip system can refer to the schematic structural diagram of the chip shown in FIG. 10. The chip shown in FIG. 10 includes a processor 1401 and an interface 1402. There may be one or more processors 1401, and there are a plurality of interfaces 1402.

In an embodiment of the disclosure, the chip further includes a memory 1403 for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a readable storage medium having an instruction stored thereon. When the instruction is executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer programs on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs)) or wirelessly (e.g., by using infrared wave, wireless wave, or microwave). The computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

The disclosure provides a network communication method and a network communication apparatus, to solve the problems of poor communication quality for edge users and frequent cell handover in the existing multi-node cooperative network architecture.

Based on the disclosure, an example of a specific solution is provided below.

### 1. Network Device

1). Parameters of one or more first TRP clusters is determined or configured, in which the parameters are classified into the following two types:
a) the first-type parameters are determined by a protocol, including a search frequency point position during the initial access, which is similar to a synchronization grid; and
b) the second-type parameters are determined by the network device and sent via a broadcast signaling, including at least one of:
a time synchronization parameter, e.g., a system frame number, a half-frame indication, etc.;
a frequency synchronization parameter, e.g., an initial BWP; or
a system message, e.g., a PLMN, a TRP cluster ID, a TRP cluster barred, etc.
2). In response to a random access request of the UE, a random access procedure of the UE is completed.
3). After the random access is completed and the UE enters an RRC connected state, a state of the UE is updated, and configuration information of a second TRP cluster is indicated to the UE.

The configuration information includes at least one of:
a TRP cluster ID;
a frequency point; a bandwidth; a time domain resource position;
a reference signal resource configuration; a reference signal reporting configuration; or
beam information and a beam index.

### 2. UE

1). The configuration parameter of the first TRP cluster is determined and received. When a paging message is received or an uplink service arrives, TRP cluster selection or reselection is performed based on the configuration parameter of the first TRP cluster, and an appropriate resident TRP cluster is selected to initiate random access. The UE includes at least one of the following operations, including:
a) receiving a synchronization signal via initial frequency point search to complete downlink synchronization;
b) receiving a parameter broadcast by the network device;
c) initiating the random access, completing the random access and uplink synchronization, and entering an RRC connected state; or
d) receiving the configuration parameter of the second TRP cluster.
2). Data transmission is performed based on the configuration parameter of the second TRP cluster.

In conclusion, the disclosure has the following beneficial technical effects. The network device may configure the two TRP clusters, and periodically sends the first configuration information of the at least one first TRP cluster to the UE, to cause the UE, in the idle state or the inactive state, to select the resident TRP cluster from the at least one first TRP cluster to complete the initial access by using the resident TRP cluster. After the UE completes the initial access, the network device sends the second configuration information of the second TRP cluster to the UE, so that the UE may access the second TRP cluster for performing the data transmission according to the second configuration information. According to the technical solution in the disclosure, for the multi-node cooperative transmission network architecture, different access and handover modes are provided for the UE in different states, thereby ensuring that UE in the idle state or the inactive state may effectively access the network during the initial access.

Those skilled in the art understand that “first”, “second” and other numerical numbers involved in the disclosure are only used for the convenience of differentiation, and are not used to limit the scope of the embodiments of the disclosure, or indicate the order of precedence.

The term “at least one” in the disclosure may also be described as one or more, and the term “multiple” may be two, three, four or more, which is not limited in the disclosure. In embodiments of the disclosure, for a type of technical features, “first”, “second” and “third”, and “A”, “B”, “C” and “D” are used to distinguish different technical features of the type, the technical features described using the terms “first”, “second” and “third”, and “A”, “B”, “C” and “D” do not indicate any order of precedence or magnitude.

As used herein, the terms “machine-readable medium” and “computer-readable medium” refer to any computer program product, device, and/or apparatus (e.g., disk, Compact Disc Read-Only Memories (CD-ROM), memory, Programmable Logic Device (PLD)) used to provide machine instructions and/or data to a programmable processor, including machine-readable medium that receives machine instructions as machine-readable signals. The term “machine-readable signal” refers to any signal used to provide machine instructions and/or data to the programmable processor.

The systems and technologies described herein can be implemented in a computing system that includes back-end components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of the back-end components, the middleware components and the front-end component. The components of the system may be interconnected by any form or medium of digital data communication (e.g., a communication network). Examples of communication networks include: a local area network (LAN), a wide area network (WAN), and the Internet.

The computer system may include a client and a server. The client and the server are generally remote from each other and interacting through a communication network. The client-server relation is generated by computer programs running on the respective computers and having a client-server relation with each other.

It is understandable that the steps can be reordered, added or deleted using various forms of the processes shown above. For example, the steps in the disclosure may be performed in parallel, sequentially, or in different orders, as long as the desired results of the technical solutions disclosed in the disclosure are achieved, which are not limited herein.

In addition, it should be understood that the embodiment of the disclosure can be implemented independently or in combination with other embodiments if the solution permits.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above may be referred to the corresponding processes in the preceding method embodiments, which will not be repeated herein.

The above are only specific implementations of the disclosure, but the scope of protection of the disclosure is not limited thereto. Those skilled in the art familiar to the technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. A network communication method, performed by a network device, comprising:
sending first configuration information of at least one first transmit and receive point (TRP) cluster to a user equipment (UE), wherein the first configuration information is used for the UE, in an idle state or an inactive state, to select a resident TRP cluster for initial access from the at least one first TRP cluster;
in response to the UE completing the initial access, updating a radio resource control (RRC) state of the UE to a connected state; and
sending second configuration information of a second TRP cluster to the UE, wherein the second configuration information is used for the UE, in the connected state, to access the second TRP cluster for performing data transmission.

2. The method of claim 1, further comprising:
determining, via a protocol agreement, a search frequency point position of the UE during the initial access, wherein the search frequency point position is used for the UE to receive a synchronization signal and a system message to complete downlink synchronization.

3. The method of claim 1, wherein the first configuration information comprises a configuration parameter, and sending the first configuration information of the at least one first TRP cluster to the UE comprises:
sending the configuration parameter periodically via a broadcast signaling, wherein the configuration parameter comprises at least one of a time synchronization parameter, a frequency synchronization parameter or a system message.

4. The method of claim 1, further comprising:
in response to a random access request sent by the UE using the resident TRP cluster, establishing an RRC connection with the UE.

5. The method of claim 1, wherein before sending the second configuration information of the second TRP cluster to the UE, the method further comprises:
sending third configuration information and a reference signal to the UE, wherein the third configuration information is used for the UE to measure the reference signal to obtain a channel measurement result.

6. The method of claim 5, further comprising:
determining or updating the second TRP cluster for the UE to perform the data transmission according to the channel measurement result.

7. The method of claim 6, further comprising:
receiving the channel measurement result sent by the UE.

8. The method of claim 1, wherein the second configuration information comprises at least one of:
a TRP cluster identifier (ID);
a frequency point;
a bandwidth;
a time domain resource position;
a reference signal resource configuration;
a measurement result reporting configuration;
beam information; or
a beam index.

9. A network communication method, performed by a user equipment (UE), comprising:
receiving first configuration information of at least one first transmit and receive point (TRP) cluster sent by a network device;
in response to the UE being in an idle state or an inactive state, selecting a resident TRP cluster for initial access from the at least one first TRP cluster according to the first configuration information, and establishing a radio resource control (RRC) connection with the network device by using the resident TRP cluster;
in response to the UE completing the initial access, receiving, in a connected state, second configuration information of a second TRP cluster sent by the network device; and
accessing the second TRP cluster according to the second configuration information for performing data transmission.

10. The method of claim 9, further comprising:
determining, via a protocol agreement, a search frequency point position during the initial access, wherein the search frequency point position is used for the UE to receive a synchronization signal and a system message to complete downlink synchronization.

11. The method of claim 10, wherein the first configuration information comprises a configuration parameter, and receiving the first configuration information of the at least one first TRP cluster sent by the network device comprises:
receiving, at the search frequency point position, the configuration parameter periodically sent by the network device via a broadcast signaling, wherein the configuration parameter comprises at least one of a time synchronization parameter, a frequency synchronization parameter or a system message.

12. The method of claim 9, wherein establishing the RRC connection with the network device by using the resident TRP cluster comprises:
sending a random access request to the network device via the resident TRP cluster, to cause the network device to establish the RRC connection with the UE in response to the random access request.

13. The method of claim 9, further comprising:
receiving third configuration information and a reference signal sent by the network device; and
measuring the reference signal according to the third configuration information to obtain a channel measurement result.

14. The method of claim 13, further comprising:
sending the channel measurement result to the network device, wherein the channel measurement result is used for the network device to determine or update the second TRP cluster for the UE to perform the data transmission.

15. The method of claim 9, wherein the second configuration information comprises at least one of:
a TRP cluster identifier (ID);
a frequency point;
a bandwidth;
a time domain resource position;
a reference signal resource configuration;
a measurement result reporting configuration;
beam information; or
a beam index.

16-17. (canceled)

18. A communication apparatus, comprising: a transceiver, a memory; and a processor connected to the transceiver and the memory respectively, wherein the processor is configured to control wireless signal transmission and reception of the transceiver by executing computer-executable instructions on the memory, and is capable of implementing a network communication method, wherein the method comprises:
sending first configuration information of at least one first transmit and receive point (TRP) cluster to a user equipment (UE), wherein the first configuration information is used for the UE, in an idle state or an inactive state, to select a resident TRP cluster for initial access from the at least one first TRP cluster;
in response to the UE completing the initial access, updating a radio resource control (RRC) state of the UE to a connected state; and
sending second configuration information of a second TRP cluster to the UE, wherein the second configuration information is used for the UE, in the connected state, to access the second TRP cluster for performing data transmission.

19. A non-transitory computer storage medium storing computer executable instructions which, when executed by a processor, enable the method of claim 1 to be implemented.

20. (canceled)

21. A communication apparatus, comprising: a transceiver; a memory; and a processor connected to the transceiver and the memory respectively, wherein the processor is configured to control wireless signal transmission and reception of the transceiver by executing computer-executable instructions on the memory, and is capable of implementing the method according to claim 9.

22. A non-transitory computer storage medium storing computer executable instructions which, when executed by a processor, enable the method of claim 9 to be implemented.

23. The communication apparatus of claim 18, wherein the method further comprises:
determining, via a protocol agreement, a search frequency point position of the UE during the initial access, wherein the search frequency point position is used for the UE to receive a synchronization signal and a system message to complete downlink synchronization.
